(19) United States
(12) Patent Application Publication
(10) Pub. No.: US 2022/0048521 A1
(43) Pub. Date: Feb. 17, 2022

(54) SERVER APPARATUS, SYSTEM, VEHICLE-MOUNTED APPARATUS, MEDIUM, VEHICLE, AND METHOD OF OPERATING SYSTEM

(71) Applicant: Toyota Jidosha Kabushiki Kaisha, Toyota-shi Aichi-ken (JP)

(72) Inventors: Yuki Tatsumoto, Nagoya-shi (JP); Manabu Ishihara, Nagoya-shi Aichi-ken (JP); Toshiki Kashiwakura, Ota-ku Tokyo-to (JP); Akira Sasaki, Miyoshi-shi Aichi-ken (JP); Sachin Ahire, Frisco, TX (US)

(21) Appl. No.: 17/399,346

(22) Filed: Aug. 11, 2021

(30) Foreign Application Priority Data
Aug. 11, 2020 (JP) 2020-135998

(51) Int. Cl. B60W 40/09; G06K 9/00

(52) U.S. Cl. CPC B60W 40/09; G06K 9/00832; B60W 2756/10; B60W 2540/21; B60W 2540/01

(57) ABSTRACT

A server apparatus includes a communication interface and a controller configured to transmit/receive information to/from another apparatus using the communication interface. Upon determining, based on behavior classification, that a behavior of a passenger detected from a captured image or a sound of the inside of a vehicle is threatening, the controller is configured to execute a process for evaluation of the passenger such that vehicle dispatch to the passenger is restricted.

### CROSS-REFERENCE TO RELATED APPLICATION

This application claims priority to Japanese Patent Application No. 2020-135998, filed Aug. 11, 2020, the entire contents of which are incorporated herein by reference.

### TECHNICAL FIELD

The present disclosure relates to a server apparatus, a system, a vehicle-mounted apparatus, a medium, a vehicle, and a method of operating a system.

### BACKGROUND

Various forms of technology have been proposed to ensure the safety of a driver or a fellow passenger from a passenger who exhibits threatening behavior, such as an assault, in a taxi, a vehicle for ridesharing, or the like in which unspecified passengers ride. Patent literature (PTL) 1 discloses technology for detecting a violent action of a passenger by a captured image of the inside of a vehicle and then notifying the police or the like. PTL 2 discloses technology for detecting the emotion of an occupant by biological information.

### CITATION LIST

### Patent Literature

PTL 1: JP 2016-107817 A

PTL 2: KR 10-2014-0080727

### SUMMARY

Demand exists for technology to ensure the safety of a driver or a fellow passenger against a threat posed by a passenger.

A control apparatus according to the present disclosure includes a controller. Upon determining, based on behavior classification, that a behavior of a passenger detected from a captured image or a sound of inside of a vehicle is threatening, the controller is configured to execute a process for evaluation of the passenger such that vehicle dispatch to the passenger is restricted.

A vehicle-mounted apparatus according to the present disclosure includes a communication interface and a controller configured to transmit/receive information to/from another apparatus using the communication interface. The controller is configured to transmit a captured image or information on sound of inside of a vehicle to a server apparatus, which upon determining, based on behavior classification, that a behavior of a passenger detected from the captured image or the sound of inside of the vehicle is threatening, is configured to execute a process for evaluation of the passenger such that vehicle dispatch to the passenger is restricted.

A method, according to the present disclosure, of operating a system including a server apparatus and a vehicle-mounted apparatus of a vehicle configured to transmit/receive information to/from each other includes transmitting, by the vehicle-mounted apparatus, a captured image or information on sound of inside of the vehicle to the server apparatus, and executing, by the server apparatus, a process upon determining, based on behavior classification, that a behavior of a passenger detected from the captured image or the sound is threatening, the process being for evaluation of the passenger such that vehicle dispatch to the passenger is restricted.

According to the present disclosure, the safety of a driver or a fellow passenger against a threat posed by a passenger can be ensured.

### BRIEF DESCRIPTION OF THE DRAWINGS

In the accompanying drawings:

FIG. 1 is a diagram illustrating an example configuration of an information processing system;

FIG. 2 is a diagram illustrating an example configuration of a terminal apparatus;

FIG. 3 is a diagram illustrating an example configuration of a server apparatus;

FIG. 4 is a diagram illustrating an example configuration of a vehicle;

FIG. 5 is a sequence diagram illustrating an operation example of the information processing system; and

FIG. 6 is a flowchart illustrating an operation example of the server apparatus.

### DETAILED DESCRIPTION

Embodiments are described below.

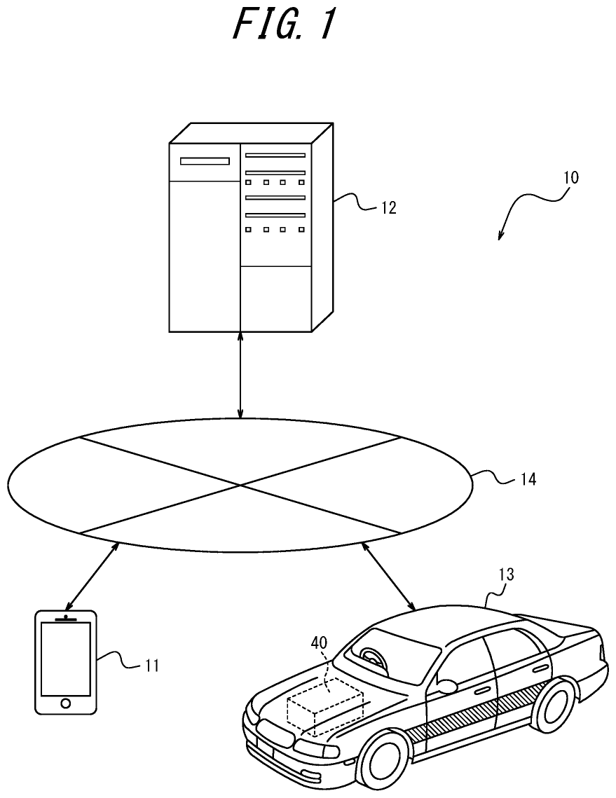

FIG. 1 is a diagram illustrating an example configuration of a control apparatus in an embodiment. An information processing system 10 assists in ensuring the safety of a driver or a fellow passenger against a threat, such as assault, posed by a passenger using ridesharing or a taxi. The information processing system 10 includes a terminal apparatus 11, a server apparatus 12, and a vehicle-mounted apparatus 40 of a vehicle 13, which communicatively connect to each other via a network 14. The terminal apparatus 11 is, for example, a mobile phone, a smartphone, a tablet, or a personal computer (PC). The server apparatus 12 is, for example, a server apparatus belonging to a cloud computing system or other computing system and implements various functions. The vehicle 13 is any vehicle that is used as a taxi or in ridesharing and carries an unspecified passenger. The vehicle-mounted apparatus 40 is, for example, a navigation apparatus, a mobile phone, a smartphone, a tablet, or a PC. The network 14 is, for example, the Internet, but may include an ad hoc network, a local area network (LAN), a metropolitan area network (MAN), or other networks, or any combination thereof.

Upon determining, based on behavior classification, that a behavior of a passenger detected from a captured image or a sound of the inside of a vehicle is threatening, the server apparatus 12 executes a process to evaluate the passenger such that vehicle dispatch to the passenger is restricted. Evaluation of the passenger is a score, for example, that indicates a tendency to exhibit threatening behavior. When this passenger requests the dispatch of a vehicle, vehicle dispatch to the passenger is restricted in accordance with the evaluation of the passenger. A passenger who has a tendency towards threatening behavior is thereby prevented from boarding the vehicle 13, and the safety of the driver or a fellow passenger can be better ensured.

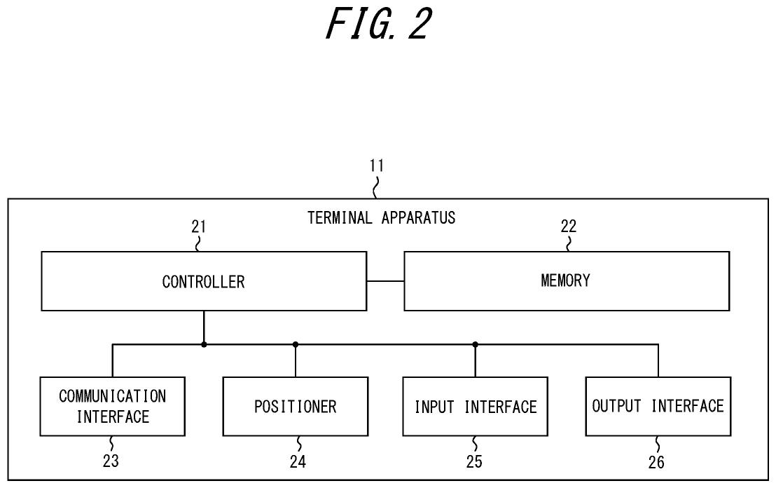

FIG. 2 illustrates an example configuration of the terminal apparatus 11. The terminal apparatus 11 includes a controller 21, a memory 22, a communication interface 23, a positioner 24, an input interface 25, and an output interface 26. The terminal apparatus 11 may, for example, be a mobile phone, a smartphone, a tablet, or a PC and is carried by a passenger or a fellow passenger.

The controller 21 includes one or more processors, one or more dedicated circuits, or a combination thereof. The processor is, for example, a general purpose processor such as a central processing unit (CPU) or a dedicated processor that is dedicated to specific processing. Examples of dedicated circuits include a field-programmable gate array (FPGA) and an application specific integrated circuit (ASIC). The controller 31 executes information processing related to operations of the terminal apparatus 11 while controlling each component of the terminal apparatus 11.

The memory 22 includes one or more semiconductor memories, one or more magnetic memories, one or more optical memories, or a combination of at least two of these. The semiconductor memory is, for example, random access memory (RAM) or read only memory (ROM). The RAM is, for example, static RAM (SRAM) or dynamic RAM (DRAM). The ROM is, for example, electrically erasable programmable ROM (EEPROM). The memory 22 functions as, for example, a main memory, an auxiliary memory, or a cache memory. The memory 22 stores information for use in operations of the terminal apparatus 11 and information resulting from operations of the terminal apparatus 11.

The communication interface 23 includes one or more interfaces for communication. Examples of the interface for communication include an interface conforming to mobile communication standards such as Long Term Evolution (LTE), 4th Generation (4G), or 5th Generation (5G), and a LAN interface. The communication interface 23 receives information for use in operations of the terminal apparatus 11 and transmits information resulting from operations of the terminal apparatus 11. The terminal apparatus 11 connects to the network 14 via a nearby router apparatus or mobile communication base station using the communication interface 23 and communicates information with other apparatuses via the network 14.

The positioner 24 includes one or more Global Navigation Satellite System (GNSS) receivers. GNSS includes, for example, Global Positioning System (GPS), Quasi-Zenith Satellite System (QZSS), Global Navigation Satellite System (GLONASS), and/or Galileo. The positioner 24 acquires positional information for the terminal apparatus 11.

The input interface 25 includes one or more interfaces for input. The interface for input is, for example, a physical key, a capacitive key, a pointing device, a touch screen integrally provided with a display, or a microphone that receives audio input. The interface for input may further include a camera or IC card reader that captures images or image codes. The input interface 25 receives an operation for inputting information used in operations of the terminal apparatus 11 and transmits the inputted information to the controller 21.

The output interface 26 includes one or more interfaces for output. The interface for output is, for example, an external or built-in display for outputting information as an image or video, a speaker for outputting information as audio, or an interface for connecting with an external output device. The display is, for example, a liquid crystal display (LCD) or an organic electro luminescence (EL) display. The output interface 26 outputs information resulting from operations of the terminal apparatus 11.

The operations of the terminal apparatus 11 are implemented by a processor included in the controller 21 executing a program. The program can be recorded on a computer readable recording medium. The computer readable recording medium is, for example, a magnetic recording device, an optical disc, a magneto-optical recording medium, or a semiconductor memory. The program is, for example, distributed as a program recorded on a portable recording medium such as a Digital Versatile Disc (DVD) or a Compact Disc (CD)-ROM. The program may be distributed by storing the program in the storage of a server apparatus and transferring the program from the server apparatus to another computer. Some or all of the operations of the terminal apparatus 11 may be performed by a dedicated circuit included in the controller 21.

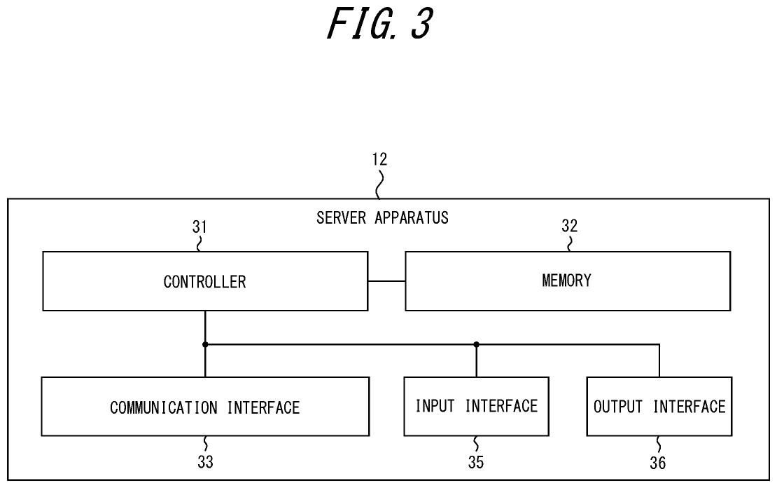

FIG. 3 illustrates an example configuration of the server apparatus 12. The server apparatus 12 includes a controller 31, a memory 32, a communication interface 33, an input interface 35, and an output interface 36. The server apparatus 12 is a server computer belonging to a cloud computing system or other computing system, for example, and functions as a server that implements various functions. The server apparatus 12 may be one or more server computers that are communicatively connected and operate in cooperation with each other.

The controller 31 includes one or more processors, one or more dedicated circuits, or a combination thereof. The processor is a general purpose processor, such as a CPU, or a dedicated processor, such as a graphics processing unit (GPU), that is dedicated to specific processing. The dedicated circuit is, for example, an FPGA or an ASIC. The controller 31 executes information processing related to operations of the server apparatus 12 while controlling each component of the server apparatus 12.

The memory 32 includes one or more semiconductor memories, one or more magnetic memories, one or more optical memories, or a combination of at least two of these, for example, functioning as a main memory, an auxiliary memory, or a cache memory. The semiconductor memory is, for example, RAM or ROM. The RAM is, for example, SRAM or DRAM. The ROM is, for example, EEPROM. The memory 32 stores information for use in operations of the server apparatus 12 and information resulting from operations of the server apparatus 12.

In the server apparatus 12, the controller 31 and the memory 32 may be connected via a bus or may be directly connected to each other without use of a bus. Alternatively, the controller 31 may house the memory 32 therein and be configured integrally with the memory 32.

The communication interface 33 includes one or more interfaces for communication. The interface for communication is, for example, a LAN interface. The communication interface 33 receives information for use in operations of the server apparatus 12 and transmits information resulting from operations of the server apparatus 12. The server apparatus 12 is connected to the network 14 by the communication interface 33 and communicates information with other apparatuses over the network 14.

The input interface 35 includes one or more interfaces for input. The interface for input is, for example, a physical key, a capacitive key, a pointing device, a touch screen integrally provided with a display, or a microphone that receives audio input. The interface for input may further include a camera or IC card reader that captures images or image codes. The input interface 35 receives an operation for inputting information used in operations of the server apparatus 12 and transmits the inputted information to the controller 31.

The output interface 36 includes one or more interfaces for output. The interface for output is, for example, a display or a speaker. The display is, for example, an LCD or an organic EL display. The output interface 36 outputs information resulting from operations of the server apparatus 12.

The functions of the server apparatus 12 are realized by execution of a control program by a processor included in the controller 31. The control program is a program for causing a computer to execute the processes of the steps included in operations of the server apparatus 12 so that the computer implements the functions corresponding to the processes of the steps. That is, the control program is a program for causing the computer to function as the server apparatus 12. Some or all of the functions of the server apparatus 12 may be realized by a dedicated circuit included in the controller 31.

In the present embodiment, the controller 31 stores information, in the memory 32, in which behaviors of the passenger in the vehicle 13 are classified as threatening or not. The behavior classifications are, for example, information that is associated with each behavior in advance and indicates whether each behavior is threatening or not. The behaviors include actions and sound by the passenger. Actions include movement of the head and limbs, a change in posture of the upper body, a change in facial expression, and the like. Threatening behaviors are, for example, violent actions accompanied by contact, such as beating or kicking a fellow passenger or the vehicle interior; preliminary actions or facial expressions not accompanied by contact but suggestive of beating, kicking or the like; and sounds that have sound pressure above a certain level and include words indicating intimidation, abusive language, or the like. Alternatively, the behavior classification may be implemented as a determination model in operations performed by the controller 21 using the memory 22. For example, the controller 21 configures a determination model by performing machine learning on training data associating behaviors with the impression given to others by the behaviors. The controller 21 then extracts the behavior of a passenger from a captured image or a sound of the inside of the vehicle 13 by image recognition or speech recognition and determines whether the behavior is threatening based on the behavior classification.

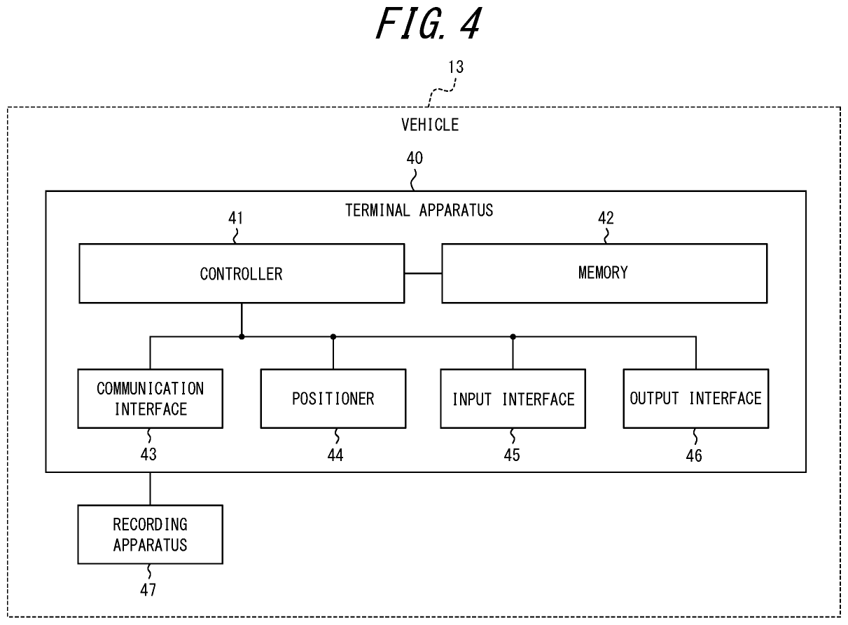

FIG. 4 illustrates a configuration example of the vehicle-mounted apparatus 40 mounted in the vehicle 13. The vehicle-mounted apparatus 40 includes a controller 41, a memory 42, a communication interface 43, a positioner 44, an input interface 45, and an output interface 46. A recording apparatus 47, controlled by the vehicle-mounted apparatus 40, is also mounted in the vehicle 13.

The controller 41 includes one or more processors, one or more dedicated circuits, or a combination thereof. The processor is a general purpose processor such as a CPU or a dedicated processor that is dedicated to specific processing. The dedicated circuit is, for example, an FPGA or an ASIC. The controller 41 executes information processing related to operations of the vehicle-mounted apparatus 40 while controlling each component of the vehicle-mounted apparatus 40.

The memory 42 includes one or more semiconductor memories, one or more magnetic memories, one or more optical memories, or a combination of at least two of these, for example, functioning as a main memory, an auxiliary memory, or a cache memory. The semiconductor memory is, for example, RAM or ROM. The RAM is, for example, SRAM or DRAM. The ROM is, for example, EEPROM. The memory 42 executes information processing related to operations of the vehicle-mounted apparatus 40 and stores information for use in operations of the vehicle-mounted apparatus 40 and information resulting from operations of the vehicle-mounted apparatus 40.

The communication interface 43 includes one or more interfaces for communication. Examples of the interface for communication include an interface corresponding to a mobile communication standard, such as LTE, 4G, or 5G. The communication interface 43 receives information for use in operations of the vehicle-mounted apparatus 40 and transmits information resulting from operations of the vehicle-mounted apparatus 40. The vehicle-mounted apparatus 40 is connected by the communication interface 43 to the network 14 via a base station for mobile object communication and communicates information with other apparatuses over the network 14.

The positioner 44 includes one or more GNSS receivers. GNSS includes, for example, GPS, QZSS, GLONASS, and/or Galileo. The positioner 44 acquires positional information for the vehicle 13.

The input interface 45 includes one or more interfaces for input. The interface for input is, for example, a physical key, a capacitive key, a pointing device, a touch screen integrally provided with a display, or a microphone that receives audio input. The interface for input may further include a camera or IC card reader that captures images or image codes. The input interface 45 receives an operation for inputting information used in operations of the vehicle-mounted apparatus 40 and transmits the inputted information to the controller 41.

The output interface 46 includes one or more interfaces for output. The interface for output is, for example, a display or a speaker. The display is, for example, an LCD or an organic EL display. The output interface 46 outputs information resulting from operations of the vehicle-mounted apparatus 40.

The functions of the vehicle-mounted apparatus 40 are realized by execution of a control program by a processor included in the controller 41. The control program is a program for causing a computer to execute the processes of the steps included in operations of the vehicle-mounted apparatus 40 so that the computer implements the functions corresponding to the processes of the steps. That is, the control program is a program for causing the computer to function as the vehicle-mounted apparatus 40. Some or all of the functions of the vehicle-mounted apparatus 40 may be realized by a dedicated circuit included in the controller 41.

The recording apparatus 47 includes one or more cameras and a corresponding control circuit. The cameras are disposed at a position enabling the capturing of an image of the seats of occupants in the cabin of the vehicle 13. The cameras provided in the recording apparatus 47 may be monocular cameras or may be stereo cameras. The recording apparatus 47 further includes a sound recorder for recording sound in the cabin of the vehicle 13 and a corresponding control circuit. The recording apparatus 47 captures images and records sounds of the inside of the vehicle 13 at any appropriate time intervals and transmits the captured images and sound information to the controller 41 of the vehicle-mounted apparatus 40.

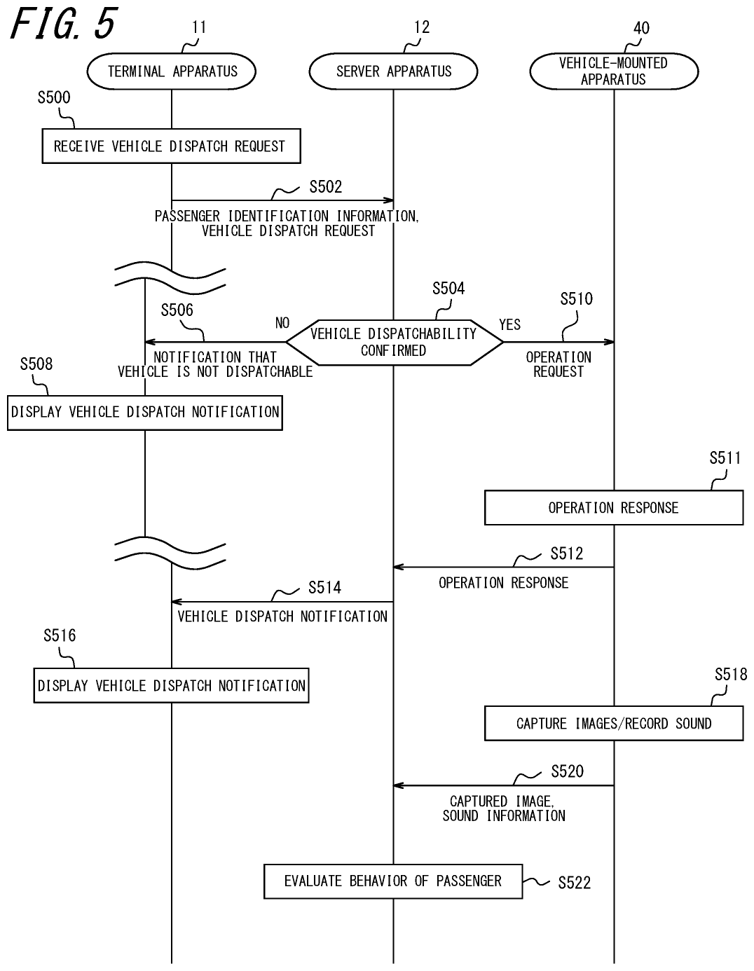

Next, operations of the information processing system 10 are described with reference to FIG. 5.

FIG. 5 is a sequence diagram illustrating operation procedures when the terminal apparatus 11, the server apparatus 12, and the vehicle-mounted apparatus 40 of the vehicle 13 operate in cooperation with each other. The procedures in FIG. 5 are performed when a passenger operates the terminal apparatus 11 to launch a vehicle dispatch application of the terminal apparatus 11.

In step S500, the terminal apparatus 11 receives a request for vehicle dispatch from a passenger. The controller 21 of the terminal apparatus 11 receives the map information from the server apparatus 12 in accordance with the current location of the terminal apparatus 11, for example, and displays the map information using the output interface 26 to prompt the passenger to input a boarding location and a drop-off location. The passenger inputs the boarding location and the like by tapping a desired point on a map or inputting an address, for example, and requests vehicle dispatch. At the time of requesting vehicle dispatch, or once when starting to use the vehicle dispatch application, the passenger inputs identification information such as a name, a user name, and a password for identifying the passenger. The controller 21 then receives the input from the passenger via the input interface 25.

In step S502, the terminal apparatus 11 transmits the identification information for the passenger and a vehicle dispatch request including the boarding location information and the like to the server apparatus 12. The controller 21 of the terminal apparatus 11 uses the communication interface 23 to transmit the passenger identification information and the vehicle dispatch request to the server apparatus 12. The controller 31 of the server apparatus 12 uses the communication interface 33 to receive the identification information for the passenger and the vehicle dispatch request.

In step S504, the server apparatus 12 determines whether a vehicle is dispatchable. Based on the identification information for the passenger, the controller 31 of the server apparatus 12 refers to the evaluation of the passenger. The evaluation of the passenger is, for example, stored in the memory 32 as a score for each passenger in association with the identification information. The scores indicate the tendency of each passenger towards threatening behavior. The score is, for example, a discrete numerical value in a freely set dynamic range. The score may, for example, indicate a greater tendency towards threatening behavior as the score in a summation formula is higher, or the score may indicate a greater tendency towards threatening behavior as the score in a subtraction formula from an initial value is lower. The controller 31 determines not to dispatch a vehicle as the tendency towards threatening behavior indicated by the passenger's evaluation is greater. For example, the controller 31 determines that a vehicle cannot be dispatched to the passenger when the score exceeds any appropriate reference value and indicates the degree of a tendency towards threatening behavior, whereas the controller 31 determines that a vehicle can be dispatched to the passenger when the score is equal to or less than the reference value. For example, the controller 31 may set three or more ranges in the score for a stepwise indication of the tendency towards threatening behavior. The controller 31 may then make a stepwise determination by determining that a vehicle can be dispatched when the score is in the lowest range, that a vehicle can be dispatched once every certain number of times in accordance with the score when the score is in the middle range, and that a vehicle cannot be dispatched when the score is in the highest range. When it is determined that the vehicle cannot be dispatched, the server apparatus 12 proceeds to the process of step S506, and when it is determined that the vehicle can be dispatched, the server apparatus 12 proceeds to the process of step S510.

In step S506, the server apparatus 12 transmits a notification to the terminal apparatus 11 indicating that the vehicle cannot be dispatched. The controller 31 of the server apparatus 12 uses the communication interface 33 to transmit the notification indicating that the vehicle cannot be dispatched to the terminal apparatus 11. The controller 21 of the terminal apparatus 11 uses the communication interface 23 to receive the notification indicating that the vehicle cannot be dispatched.

In step S508, the terminal apparatus 11 outputs a notification indicating that the vehicle cannot be dispatched. The controller 21 of the terminal apparatus 11 uses the output interface 36 to display the notification indicating that the vehicle cannot be dispatched to the passenger. The operations by the terminal apparatus 11, the server apparatus 12, and the vehicle-mounted apparatus 40 then terminate.

In step S510, on the other hand, the server apparatus 12 generates an operation request for the vehicle 13 and transmits the operation request to the vehicle-mounted apparatus 40. Based on information received from the terminal apparatus 11 such as the identification information for the passenger and the boarding location, the controller 31 of the server apparatus 12 generates an operation request for heading towards the boarding location to meet the passenger and uses the communication interface 33 to transmit the operation request to the vehicle-mounted apparatus 40. The controller 41 of the vehicle-mounted apparatus 40 uses the communication interface 43 to receive the operation request.

In step S511, the vehicle-mounted apparatus 40 generates an operation response for responding to the operation request. The controller 41 of the vehicle-mounted apparatus 40 uses the output interface 46 to display the boarding location included in the operation request to the driver, uses the input interface 45 to receive an operation by the driver responding with regard to availability for the operation request, and generates an operation response relating to operability. When operation is possible, the operation response includes information such as an identification number of the vehicle 13 and the current location of the vehicle 13. Upon generation of an operation response indicating that operation is possible, the vehicle-mounted apparatus 40 transmits the operation response to the server apparatus 12 in step S512.

The controller 41 of the vehicle-mounted apparatus 40 uses the communication interface 43 to transmit the operation response to the server apparatus 12. The controller 31 of the server apparatus 12 uses the communication interface 33 to receive the operation response.

In step S514, the server apparatus 12 generates a vehicle dispatch notification corresponding to the operation response and transmits the vehicle dispatch notification to the terminal apparatus 11. The controller 31 of the server apparatus 12 calculates the estimated arrival time to the boarding location based on the current location of the vehicle 13, for example. The controller 31 then generates the vehicle dispatch notification to include the identification number, the current location, the estimated arrival time, and the like of the vehicle 13. The controller 31 then uses the communication interface 33 to transmit the vehicle dispatch notification to the terminal apparatus 11. The controller 21 of the terminal apparatus 11 uses the communication interface 23 to receive the vehicle dispatch notification.

In step S516, the terminal apparatus 11 outputs the vehicle dispatch notification to the passenger. The controller 21 of the terminal apparatus 11 uses the output interface 36 to display the vehicle dispatch notification to the passenger. For example, together with text information such as “vehicle dispatch complete”, the estimated arrival time and the like of the vehicle 13 to the boarding location are displayed. Once the vehicle 13 arrives at the boarding location, the passenger boards the vehicle 13 and begins riding.

After riding beings, steps S518, S520 and S522 are performed over any appropriate cycle, such as every few seconds to several tens of seconds.

In step S518, the vehicle-mounted apparatus 40 captures images and records sound of the inside of the vehicle 13. In step S520, the vehicle-mounted apparatus 40 then transmits the captured images and sound information to the server apparatus 12. In the vehicle 13, the recording apparatus 47 captures images at any appropriate frame rate, records sound accompanying the images, and transmits the captured images and sound information associated with the captured images to the vehicle-mounted apparatus 40. The controller 41 of the vehicle-mounted apparatus 40 uses the communication interface 43 to transmit the captured images and the sound information to the server apparatus 12. The controller 31 of the server apparatus 12 uses the communication interface 33 to receive the captured images and sound information and stores the captured images and sound information in the memory 32.

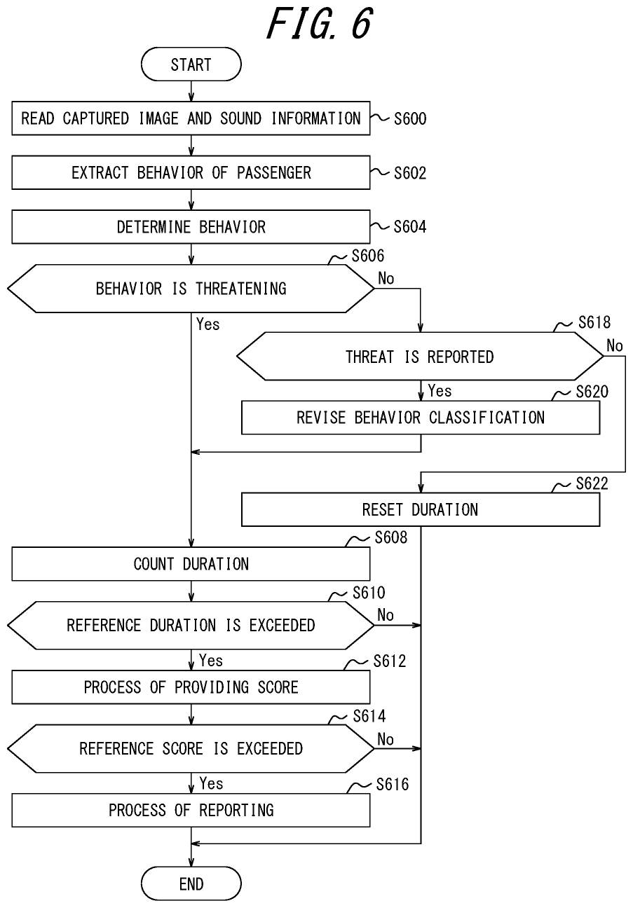

In step S522, the server apparatus 12 evaluates the behavior of the passenger, detected from the captured images or sound of the inside of the vehicle, based on the behavior classification. Details of the procedure in step S522 are illustrated in FIG. 6.

FIG. 6 is a flowchart illustrating a processing procedure by the controller 31 in the server apparatus 12.

In step S600, the controller 31 reads any number of frames of captured images and the sound information associated with the captured images from the memory 32.

In step S602, the controller 31 extracts the behavior of the passenger from the captured images and sound information. For example, the controller 31 performs image recognition processing and speech recognition processing and uses pattern matching or the like to extract the behavior of the passenger from the captured images and sound information.

In step S604, the controller 31 determines whether the extracted behavior is threatening. For example, the controller 31 determines whether the extracted behavior is threatening based on the behavior classification. For example, the controller 31 determines that behavior is threatening when the behavior is a violent action accompanied by contact, such as beating or kicking a fellow passenger or the vehicle interior; a preliminary action or facial expression not accompanied by contact but suggestive of beating, kicking or the like; or sound that has sound pressure above a certain level and includes words indicating intimidation, abusive language, or the like. When no particular behavior is extracted, or when the extracted behavior does not correspond to a violent action, preliminary action, intimidation, abusive language, or the like, the controller 31 determines that the behavior is not threatening. When the behavior is determined to be threatening (step S606: Yes), the controller 31 proceeds to step S608. Conversely, when the behavior is determined not to be threatening (step S606: No), the controller 31 proceeds to step S618.

In step S608, the controller 31 counts the duration of the threatening behavior. For example, the controller 31 accumulates the elapsed time since threatening behavior was detected in the last process cycle and stores the result in the memory 32.

In step S610, the controller 31 determines whether the duration of the threatening behavior exceeds a reference duration. For example, the controller 31 determines whether the duration counted in step S608 exceeds any appropriate reference time (such as a few seconds to several tens of seconds). When the duration exceeds the reference time (step S610: Yes), the controller 31 proceeds to step S612, whereas when the duration does not exceed the reference time (step S610: No), the controller 31 terminates the processing cycle of FIG. 6.

In step S612, the controller 31 performs a process of providing a score to the passenger. In other words, the behavior of the passenger is evaluated. The controller 31 stores the score in the memory 32 in association with the identification information for the passenger. For example, the controller 31 increases the score by any appropriate increment in the case of scoring by a summation formula, decreases the score by any appropriate decrement in the case of scoring by a subtraction formula, and stores the calculated score in the memory 32. The controller 31 adjusts the magnitude of the increase or decrease in the score in accordance with the behavior, for example. The controller 31 may, for example, increase or decrease the score to a diminishing degree in the order of a score yielded by a violent action accompanied by contact with a fellow passenger or the vehicle interior, a score yielded by a preliminary action not accompanied by contact, and a score yielded by sound. This enables evaluation to be made in accordance with the degree of the threatening behavior of the passenger.

The controller 31 can also adjust the score by, for example, taking into account the behavior of a fellow passenger. For example, the controller 31 extracts the behavior of a fellow passenger from the captured image or sound information. When the behavior of the fellow passenger exhibits disgust for the behavior of the passenger, the controller 31 can increase the weighting of the passenger's score. Examples of such behavior of the fellow passenger include the fellow passenger frowning, turning their head away, avoiding the behavior of the passenger, and complaining about the behavior of the passenger This enables more accurate evaluation of the threatening behavior of the passenger.

Furthermore, the controller 31 can, for example, adjust the scoring taking into account attributes of the passenger. For example, the controller 31 can use the identification information for the passenger to query the server of an administrative authority and weight the score in accordance with whether the passenger has a criminal record. For example, the controller 31 applies a larger weight to the score of a passenger with a criminal record than to the score of a passenger without a criminal record. Upon extracting the behavior, the controller 31 may also detect that the passenger is carrying a firearm based on the outline of clothing. In this case, the controller 31 can query the server of an administrative authority, based on the identification information for the passenger, regarding whether the passenger has permission to carry a firearm. The controller 31 can then set the score to be higher when the passenger does not have permission than when the passenger does have permission. This enables more accurate evaluation of the threatening behavior of the passenger.

In step S614, the controller 31 determines whether the score exceeds the reference score. For example, when the passenger's tendency towards threatening behavior indicated by the score provided in step S612 exceeds any appropriate reference (step S614: Yes), the controller 31 proceeds to step S616, whereas when the tendency is equal to or less than the reference (step S614: No), the controller 31 terminates the processing cycle of FIG. 6.

In step S616, the controller 31 performs a process of reporting to security authorities, such as the police. When the passenger exhibits an excessive tendency towards threatening behavior, this configuration enables the authorities to be notified of potential danger in the vehicle 13 and can contribute to ensuring the safety of the driver or fellow passengers.

If the threatening behavior of the passenger subsides in a relatively short period of time, it may be hoped that the passenger's tendencies will improve. The reference time for the determination in step S610 may therefore be set to any appropriate length to prevent the evaluation of the passenger from becoming unnecessarily worse and to reduce the burden on the authorities by avoiding unnecessary reporting.

When the behavior of the passenger is determined not to be threatening (S606: No), the controller 31 determines, in step S618, whether the driver or a fellow passenger reported a threat. For example, when perceiving the behavior of the passenger as threatening, the driver or fellow passenger inputs a report of the threatening behavior to the input interface 45 of the vehicle-mounted apparatus 40. For example, the driver or fellow passenger provides the input to an alarm button, tap area, or the like in the vehicle-mounted apparatus 40. The controller 41 of the vehicle-mounted apparatus 40 then responds to the input and uses the communication interface 43 to transmit a report indicating the threat to the server apparatus 12. Alternatively, the terminal apparatus carried by a fellow passenger may communicatively connect to the vehicle-mounted apparatus 40 by short range communication or mobile object communication or communicatively connect to the server apparatus 12 by mobile object communication. A report may then be transmitted to the vehicle-mounted apparatus 40 or the server apparatus 12 by the fellow passenger operating a dedicated application of the terminal apparatus. The controller 31 of the server apparatus 12 uses the communication interface 43 to receive the report. When the report is received (S618: Yes), the controller 31 proceeds to step S620, and when the report is not received (S618: No), the controller 31 proceeds to step S622.

In step S620, the controller 31 revises the behavior classification to associate the threat with the extracted behavior. The controller 31 revises the information, stored in the memory 32, in which behaviors are classified as threatening or not. The controller 31 may also associate the extracted behavior with a threatening impression and reflect the association in the training data that associates behaviors with the impression given to others by the behaviors. The controller 31 may thus revise the training data and then perform machine learning. This can improve the accuracy of subsequent behavior determination. The controller 31 then executes the steps from step S608 onward. That is, since the passenger is exhibiting threatening behavior in this case, the controller 31 performs the process to provide a score and the process for reporting in accordance with the score.

When no threat report is made (S618: No), the controller 31 resets the count of the duration of the threatening behavior in step S622. The processing cycle of FIG. 6 then terminates.

The subsequent determination of whether to dispatch a vehicle in step S504 of FIG. 5 is made based on the evaluation of the passenger evaluated by the procedure of FIG. 6. Vehicle dispatch to the passenger is therefore restricted in accordance with the passenger's tendency towards threatening behavior. This can reduce the probability that the driver or a fellow passenger will ride with a passenger with a strong tendency towards threatening behavior, thereby ensuring the safety of the driver or fellow passenger.

In the above embodiment, a processing/control program that specifies operations of the terminal apparatus 11 or the vehicle-mounted apparatus 40 may be stored in the server apparatus 12 and be downloaded onto each apparatus via the network 14. The processing/control program may also be stored on a non-transitory recording/storage medium readable by each apparatus, and each apparatus may read the program from the medium.

The present disclosure is not limited to the embodiments described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

1. A server apparatus comprising:
a communication interface; and
a controller configured to transmit/receive information to/from another apparatus using the communication interface, wherein
upon determining, based on behavior classification, that a behavior of a passenger detected from a captured image or a sound of inside of a vehicle is threatening, the controller is configured to execute a process for evaluation of the passenger such that vehicle dispatch to the passenger is restricted.

2. The server apparatus of claim 1, wherein the controller is configured to adjust the evaluation of the passenger in accordance with behavior, detected from the captured image or the sound, of a fellow passenger in the vehicle.

3. The server apparatus of claim 1, wherein the controller is configured to adjust the evaluation of the passenger in accordance with a report, from a fellow passenger in the vehicle, transmitted by a terminal apparatus.

4. The server apparatus of claim 1, wherein the controller is configured to adjust the evaluation of the passenger in accordance with an attribute of the passenger.

5. The server apparatus of claim 1, wherein the controller is configured to execute a process for issuing a report upon the evaluation exceeding a reference.

6. The server apparatus of claim 2, wherein the controller is configured to execute a process for issuing a report upon the evaluation exceeding a reference.

7. The server apparatus of claim 3, wherein the controller is configured to execute a process for issuing a report upon the evaluation exceeding a reference.

8. The server apparatus of claim 4, wherein the controller is configured to execute a process for issuing a report upon the evaluation exceeding a reference.

9. A system comprising the server apparatus according to claim 1 and a vehicle.

10. A vehicle-mounted apparatus comprising:
a communication interface; and
a controller configured to transmit/receive information to/from another apparatus using the communication interface, wherein
the controller is configured to transmit a captured image or information on sound of inside of a vehicle to a server apparatus, which upon determining, based on behavior classification, that a behavior of a passenger detected from the captured image or the sound of inside of the vehicle is threatening, is configured to execute a process for evaluation of the passenger such that vehicle dispatch to the passenger is restricted.

11. A non-transitory medium readable by a vehicle-mounted apparatus and storing a program that, when executed by a controller of the vehicle-mounted apparatus, causes the vehicle-mounted apparatus to operate as the vehicle-mounted apparatus of claim 10.

12. A vehicle comprising the vehicle-mounted apparatus of claim 10.

13. A method of operating a system comprising a server apparatus and a vehicle-mounted apparatus of a vehicle configured to transmit/receive information to/from each other, the method comprising:
transmitting, by the vehicle-mounted apparatus, a captured image or information on sound of inside of the vehicle to the server apparatus; and
executing, by the server apparatus, a process upon determining, based on behavior classification, that a behavior of a passenger detected from the captured image or the sound is threatening, the process being for evaluation of the passenger such that vehicle dispatch to the passenger is restricted.

14. The method of operating a system of claim 13, further comprising adjusting, by the server apparatus, the evaluation of the passenger in accordance with behavior, detected from the captured image or the sound, of a fellow passenger in the vehicle.

15. The method of operating a system of claim 13, further comprising adjusting, by the server apparatus, the evaluation of the passenger in accordance with a report, from a fellow passenger in the vehicle, transmitted by a terminal apparatus.

16. The method of operating a system of claim 13, further comprising adjusting, by the server apparatus, the evaluation of the passenger in accordance with an attribute of the passenger.

17. The method of operating a system of claim 13, further comprising executing, by the server apparatus, a process for issuing a report upon the evaluation exceeding a reference.

18. The method of operating a system of claim 14, further comprising executing, by the server apparatus, a process for issuing a report upon the evaluation exceeding a reference.

19. The method of operating a system of claim 15, further comprising executing, by the server apparatus, a process for issuing a report upon the evaluation exceeding a reference.

20. The method of operating a system of claim 16, further comprising executing, by the server apparatus, a process for issuing a report upon the evaluation exceeding a reference.
